(19) United States
(12) Patent Application Publication
(10) Pub. No.: US 2025/0123593 A1
(43) Pub. Date: Apr. 17, 2025

(54) MAGNETIC CONTROL AND/OR DRIVE MECHANISM THROUGH A WATCH CASE

(71) Applicant: The Swatch Group Research and Development Ltd, Marin (CH)

(72) Inventors: Lionel PARATTE, Marin-Epagnier (CH); Dominique LECHOT, Les Reussilles (CH); Jean-Jacques BORN, Morges (CH)

(73) Assignee: The Swatch Group Research and Development Ltd, Marin (CH)

(21) Appl. No.: 18/691,959

(22) PCT Filed: Jun. 14, 2022
(86) PCT No.: PCT/EP2022/066203

§ 371 Date: Mar. 14, 2024

(30) Foreign Application Priority Data
Oct. 26, 2021 (EP) 21204666.8

(51) Int. Cl. G04B 18/02; G04B 23/02; G04B 37/02

(52) U.S. Cl. CPC G04B 18/021; G04B 23/021; G04B 37/02

(57) ABSTRACT

One aspect of the invention relates to a horological assembly (2000) including a watch (1000) and an adjustment tool (200) for driving, without direct contact, a first mobile (1) internal to the watch (1000) throughout its case, for adjustment and/or recharging, the adjustment tool (200) including first magnetic areas (210) cooperating in attraction or repulsion with the first mobile (1) which is pivotably and axially movable about a first axis (D1) against an elastic return means (5) fastened to the case (10), between an active position in which the adjustment tool (200) draws the first mobile (1) towards an end-of-travel surface (6) in an engaged position with a second mobile (7) inside the case (10), and an inactive position in the absence of the adjustment tool (200) and in which the elastic return means (5) keeps the first mobile (1) disengaged from the second mobile (7).

### TECHNICAL SCOPE OF THE INVENTION

The invention relates to a horological assembly including at least one watch, and an adjustment tool, for driving without direct contact a first mobile internal to the watch throughout its case, for adjustment and/or energy recharging.

The invention relates to the field of adjustment and/or drive control mechanisms for timepieces.

### TECHNOLOGICAL BACKGROUND

There are many systems for mechanically adjusting the functions of a wristwatch through the casing, such as push-pieces, crowns and the like. However, any mechanical element that passes through the casing must be watertight, for example by using O-rings or other seals, with all the problems that this entails.

In addition, some movement adjustments, such as the rate, are best made when the watch is closed, as the casing operation often results in a difference between the adjustment made to the movement and the finished watch.

For these two main reasons, it is desirable to have a mechanical coupling system to functions internal to the watch, which can pass through the casing in a way other than a mechanical arbor fitted with a seal.

### SUMMARY OF THE INVENTION

The purpose of the invention is to implement means for transmitting a torque or a force through a watch casing by means of a magneto-coupler, in order to carry out a mechanical adjustment, for example an adjustment of the rate, once the watch is finished (cased movement).

To this end, the invention relates to a horological assembly according to claim 1.

### BRIEF DESCRIPTION OF THE FIGURES

The aims, advantages and features will be better understood upon reading the following detailed description, with reference to the appended figures, where:

FIGS. 1 to 5 illustrate a first variant of a horological assembly according to the invention, including an adjustment tool arranged to cooperate with a watch of a given type, specific to this particular horological assembly:

FIG. 1 shows a schematic representation of such a watch, in part and in section passing through the axis of rotation of a first mobile internal to the watch, which is axially movable and rotatable about this first axis, and which carries a control pinion shown here in the disengaged position relative to a plate which includes an internal mechanism of the watch;

FIG. 2 shows a schematic plan of this first mobile, in this case a ferromagnetic cross;

FIG. 3 shows a schematic plan of an elastic return means, in this case a spiral spring, which tends to return the first mobile to its disengaged position, as seen in FIG. 1;

FIG. 4 shows a schematic plan of the adjustment tool used to pair up with this first mobile, and which includes four magnets in a cross, on the same radius, and of alternating polarity; in this case, a ferromagnetic cross;

FIG. 5 shows, in a similar way to FIG. 1, the cooperation between the adjustment tool in FIG. 4 and the first mobile in FIG. 2, bringing the latter into its engaged position, where the pinion meshes with the plate, the first mobile being in the front stop position, here in relation to a crystal in the watch case;

FIGS. 6 and 7 illustrate a second generic variant, with a first internal mobile, which herein has an irregular contour, which includes in this non-limiting example five arms unequally distributed angularly, and of variable radial amplitude; the corresponding adjustment tool includes five magnets, three of which are on the same radius, and two others on other radius values; among these five magnets, four have the same polarity facing the first internal mobile, whereas one single magnet has the opposite polarity:

FIG. 6 is a schematic plan view of this first internal mobile with five unequal arms, mirrored, the external adjustment tool for pairing with this first mobile, which includes five magnets as described above;

FIG. 7 shows, in a similar way to FIG. 5, the cooperation between the adjustment tool and the first mobile of FIG. 6, and illustrates the cooperation (and withdrawal in the disengaged position with the illustration of the pinion in dashed line) between the first internal mobile and the adjustment tool of FIG. 6, with alignment of the first axis D1 and the second axis D2. The looping of the magnetic fluxes throughout the ferromagnetic areas of the first internal mobile and the magnets of the adjustment tool is schematised by closed loops, one with a solid line and the other with a dashed line;

FIG. 8 is a block diagram showing a horological assembly including a single adjustment tool, capable of cooperating with different watches in the assembly, which include the same first internal mobile.

### DETAILED DESCRIPTION OF THE INVENTION

The patent document EP3252545A1 describes a system for magnetic coupling between the inside and outside of the casing, which system enables the winding arbor to be engaged to a rate adjustment system by changing the inertia of a special balance wheel. In particular, an encrypted external magnetic key, equipped with permanent magnets, rotates an internal ring, equipped with ferromagnetic targets, by magneto-mechanical coupling.

The ring is locked in rotation, either by axial elastic retention against a blocker, or by a blocking device secured to the axial movement of the shaft, thus guaranteeing retention thereof against rotary shocks.

This high-performance system essentially serves to relay the torque of the arbor, which is the sole guarantor of the internal mechanical function, in this case the change in inertia of the special balance. It is therefore not suitable, on its own, for providing the torque required for the considered adjustment, or for recharging with energy. The magnetic feedthrough system must cooperate with another energy supply system, which must also be adapted to the magnetic relay. The whole therefore forms a relatively complex system.

The invention proposes a system similar to that described in the patent document EP3252545A1, but independent of any push-piece or of the arbor, and therefore capable of producing direct torque/force, this new system also being encrypted and having its own mechanical locking/unlocking function, and whose implementation is simplified.

The invention thus relates to a horological assembly 2000 including at least one watch 1000, and at least one adjustment tool 200, which is arranged so as to enable a first internal mobile 1 that each watch 1000 of this horological assembly 2000 includes to be driven, without direct contact, throughout a case 10 that each watch 1000 includes, in order to carry out an adjustment and/or an energy recharge. Each adjustment tool 200 includes first magnetic areas 210, which are arranged to cooperate in a complementary manner, by attraction or repulsion, with the first internal mobile 1 which is ferromagnetic or which includes second magnetic areas.

The invention is illustrated by variants where this cooperation takes place by attraction; of course, alternative mechanisms can also be developed on the basis of cooperation by repulsion.

According to the invention, the first internal mobile 1 is pivotably movable about a first axis D1, and is also axially movable according to the direction of the first axis D1 against an elastic return means 5 which is fastened to the case 10, or to an element 2 of the case 10 or fastened to the case 10, or to a fixed element of the internal structure of the watch 1000 such as a plate or the like. This axial mobility of the first internal mobile 1 is exercised between, on the one hand, an active position in which the adjustment tool 200 is positioned against the watch 1000 or in the vicinity of the watch 1000 so as to attract, in the illustrated alternative of operation by attraction, or respectively push back, in the other alternative of operation by repulsion, the first internal mobile 1 towards an end-of-travel surface 6 included in the elastic return means 5 or the element 2 or the case 10, or a fixed element of the internal structure of the watch 1000, in an engaged position between a first drive element 3 secured to the first internal mobile 1 or formed by the first internal mobile 1 and a second internal mobile 7 internal to the case 10, and on the other hand an inactive position in the absence of the adjustment tool 200, in which inactive position the elastic return means 5 keeps the first drive element 3, or the first internal mobile 1 itself depending on the adopted configuration, disengaged from the second internal mobile 7.

More particularly, the first magnetic areas 210 are arranged to cooperate, in the active position, in a complementary manner by axial attraction or repulsion parallel to the direction of the first axis D1 with the first internal mobile 1.

More particularly, the first internal mobile 1 includes a plurality of radial arms 101, 102, defining, in projection on a plane perpendicular to the first axis D1, a particular geometrical shape, and the first magnetic areas 210 include a plurality of magnets 201, 202, which are arranged radially around a second axis D2 according to this particular geometrical shape, so as to achieve an encoded magneto-mechanical connection specific to the single horological assembly 2000 under consideration.

In one variant, the first magnetic areas 210 include a plurality of magnets 201, 202, which are arranged radially around a second axis D2 according to the direction of which their magnetic field axis extends, and which alternate in polarity.

In a particular variant, the first internal mobile 1 is ferromagnetic.

In a particular variant, the first internal mobile 1 includes at least one magnet.

More particularly, the first ferromagnetic internal mobile 1 has a particular shape, which is arranged to minimise the effects of attraction, rotation or repulsion of a uniform external magnetic field of typically 1.5 Tesla, and to minimise the rotation of the first internal mobile 1, in particular ferromagnetic, under the action of a uniform external magnetic field of typically 1.5 Tesla.

The first internal mobile 1 cannot be rotated with one single magnet of any size and strength by a user or by a repairer from outside the manufacturer's network, who can ultimately engage the clutch but not rotate the first internal mobile 1.

More particularly, the first ferromagnetic internal movable 1 includes a plurality of radial arms 101, 102, which extend radially to the largest radius in which the first internal mobile 1 is movable about the first axis D1.

More particularly, the element 2 is a component made of non-magnetic material, such as glass, sapphire, ceramic, an aluminium alloy, a titanium alloy, stainless steel or plastic. Even more particularly, the element 2 is a crystal.

More specifically, the first internal mobile 1 is pivotably guided about a first axis D1 by a shaft 4 or a bearing which at least one watch 1000 includes.

More particularly, at least one watch 1000 of the horological assembly 2000 is a non-magnetic watch. Even more particularly, each watch 1000 in the horological assembly 2000 is a non-magnetic watch.

More particularly, at least one watch 1000 of the horological assembly 2000 is a non-magnetic watch. Even more particularly, each watch 1000 of the horological assembly 2000 is a mechanical watch.

More particularly, at least one watch 1000 of the horological assembly 2000 is a non-magnetic watch. Even more particularly, each watch 1000 of the horological assembly 2000 is an electromechanical or electronic watch.

More particularly, the second internal movement 7 is a movement for controlling the rate setting of a regulating member included in at least one watch 1000.

More particularly, the second internal movement 7 is a mobile for controlling the time setting of at least one watch 1000.

More particularly, the second internal mobile 7 is a mobile for controlling the setting of a calendar mechanism included in at least one watch 1000.

More particularly, the second internal mobile 7 is a winding control mobile for at least one watch 1000.

More particularly, the second internal mobile 7 is a mobile for controlling the setting of an alarm and/or striking work mechanism included in at least one watch 1000.

More particularly, the first internal mobile 1 is invisible to the user of at least one watch 1000.

More particularly, at least one watch 1000 is devoid of any external mechanical adjusting member passing through the casing of the watch 1000.

More particularly, at least one watch 1000 is sealed against gases and ambient humidity, and its casing includes for this purpose at least one sealing area suitable for carrying out a metallic or ceramic or glass sealing treatment in a vacuum or in a neutral gas atmosphere.

More particularly, at least one watch 1000 is sealed to be depressurised so as to be insensitive to variations in internal pressure variations caused by variations in temperature.

More particularly, at least one watch 1000 is equipped with an RFID chip or a passive means of identification enabling direct identification of the nature of the horological assembly 2000 to which the watch 1000 belongs, and the adjustment tool 200 to be used, in the after-sales service.

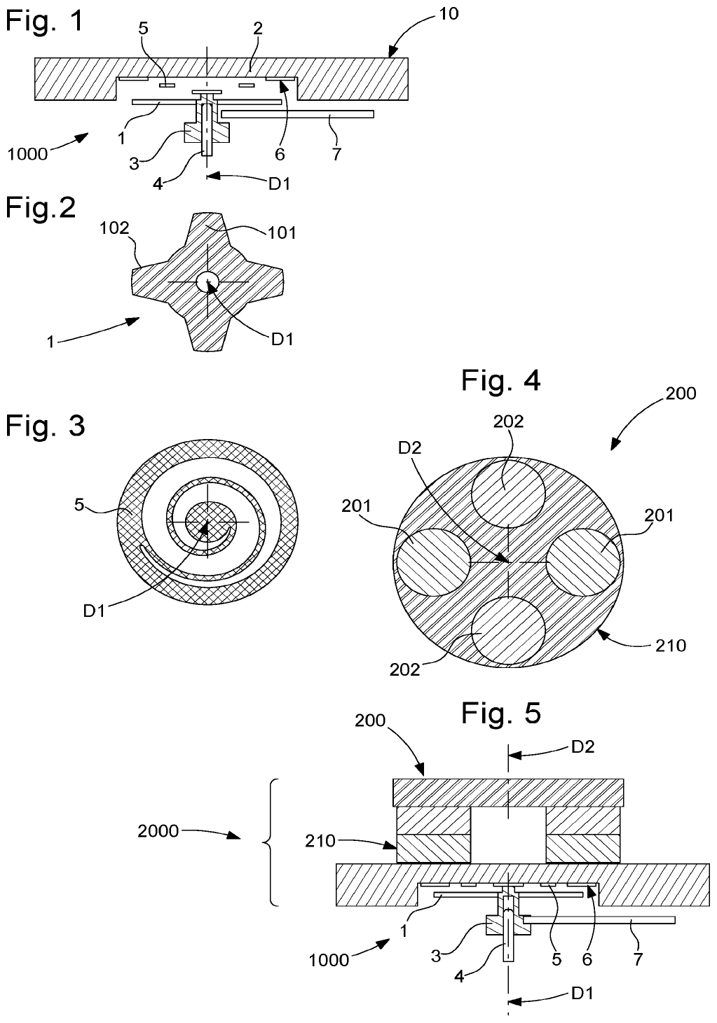

The non-limiting example illustrated by FIGS. 1 to 5 relates to such a horological assembly 2000, at least one watch 1000 of which includes a first internal mobile 1, which herein consists of a ferromagnetic cross, visible in plan view in FIG. 2, internal to the casing, the case 10 herein including a watch back crystal 2, as visible in FIG. 1, which shows the mechanism in section. This ferromagnetic cross 1 is pivotably mounted on a shaft 4 according to the first axis D1, and is also capable of sliding axially along this first axis D1. In this same example, the cross 1 is secured to a first drive element 3 which is a clutch pinion; a spring forms the elastic return means 5, visible in plan view in FIG. 3 in a particular embodiment of the spiral spring, and which keeps this clutch pinion away from its position of coupling with a second internal mobile 7, which herein includes a driven plate coupled, in the movement, to the function to be performed (the case illustrated is particularly well-suited to adjusting the rate of a balance spring by modifying the stiffness of said spiral spring).

FIG. 4 illustrates in plan view the adjustment tool 200 specific to the family of watches 1000 of the horological assembly 2000. In a very simple variant, this adjustment tool 200 is equipped with 4 magnets 201 and 202, distributed on the same radius around a second axis D2. When this adjustment tool 200, comparable to a screwdriver, is approached, the ferromagnetic cross 1 is attracted towards the crystal 2, under compression of the spring 5, and strikes against the crystal 2 at the pivot end. The driven plate 7 is now engaged with the pinion 3. Rotation of the adjustment tool 200 has a reluctant effect on the arms of the ferromagnetic cross 1, causing rotation of the internal stage.

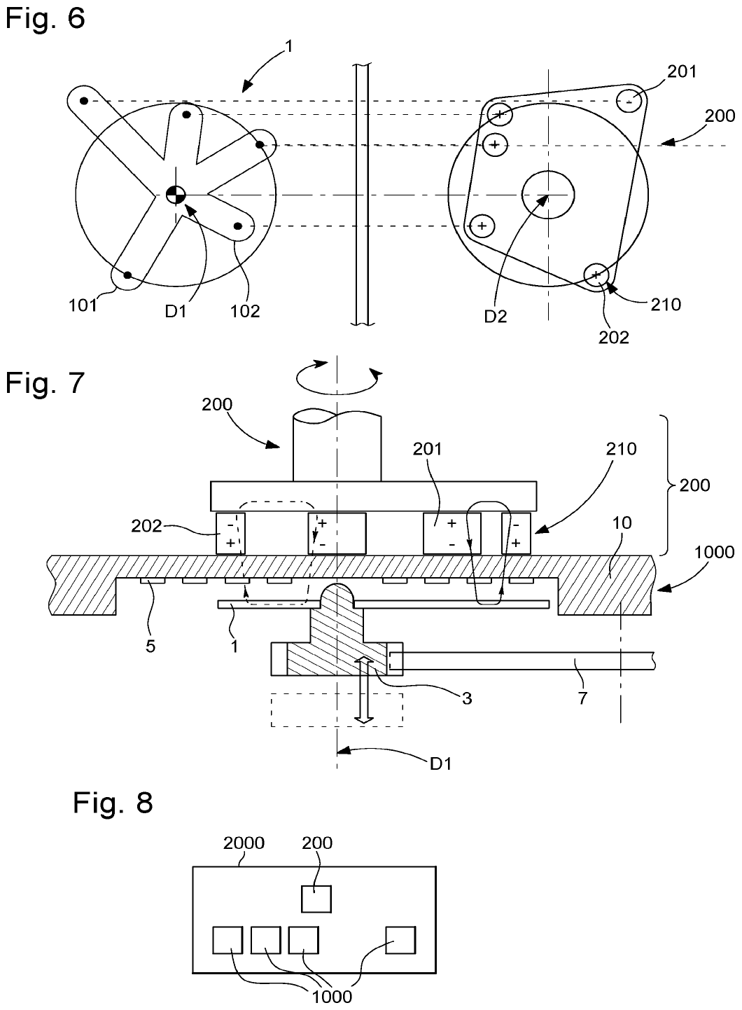

Another non-limiting example is illustrated by FIGS. 6 and 7, at least one watch 1000 includes a first internal mobile 1, which herein has an irregular contour, and includes in this example 5 arms unequally distributed angularly, and of variable radial amplitude; the corresponding adjustment tool 200 includes 5 magnets, 3 of which are on the same radius, and 2 others on other radius values; among these 5 magnets, 4 have the same polarity to the first internal mobile 1, whereas one single magnet has the opposite polarity. This adjustment tool has a magnetic yoke arranged to face the first internal mobile.

It should be understood that the cooperation between the first internal mobile 1 and the adjustment tool 200 can, to improve the tamper-proofing of the system, act on both the geometry and the combination of ad-hoc polarities. In the same way, the first internal mobile 1 may include ferromagnetic point areas and/or point magnets. The adjustment tool 200 can have any encoded shape.

Advantageously, the first internal mobile 1 has a fairly compact shape, so as to minimise its magnetic positioning torque due to any external field.

FIG. 7 illustrates the cooperation (and withdrawal in the disengaged position with the illustration of the pinion in dashed line) between the first internal mobile 1 and the adjustment tool 200 of FIG. 6, with alignment of the first axis D1 and the second axis D2. Looping of the magnetic fluxes throughout the ferromagnetic areas of the first internal mobile 1 and the magnets of the adjustment tool 200 is illustrated by closed loops, one in the form of a solid line, the other in the form of a dashed line.

The magnetic remanence of the internal elements of the mechanism: crosses, mobiles, must be low enough in order not to impair the movement or any other function of the watch.

The actual size of the system must remain small compared to the main internal functions of the watch.

Manipulation of the mechanism according to the invention should be reserved for factory production, or a specialist shop, or an after-sales service approved by the manufacturer, to avoid any problem of involuntary disruption by the customer or third parties. The cross and the key will therefore be sized to prevent any manipulation by a conventional magnet. The shape of the cross may be special and complicated, hidden by an opaque layer or not, and cooperating with an ad hoc screwdriver difficult to find on the market, with a special arrangement and dimensions of the magnets. The cross must not be able to orientate itself when a homogeneous external magnetic field of high intensity (a few Teslas) is applied and, as much as possible, should move axially as little as possible.

This system can also completely replace conventional push-pieces and arbors, making it possible to produce automatic or other watches that are much more water-resistant than current models.

1-22. (canceled)

23. A horological assembly comprising:
at least one watch and at least one adjustment tool arranged to enable a first internal mobile included in each said watch of said watchmaking assembly to be driven, without direct contact, throughout a case included in each said watch, in order to carry out an adjustment and/or a recharging with energy, each said adjustment tool including first magnetic areas arranged to cooperate in a complementary manner by attraction or repulsion with said first ferromagnetic internal mobile or including second magnetic areas,
wherein said first internal mobile is pivotably movable about a first axis, and is also movable axially according to the direction of said first axis against an elastic return means fastened to an element of said case, between an active position in which said adjustment tool is positioned against said watch or in the vicinity of said watch so as to attract, or respectively push back, said first internal mobile towards an end-of-travel surface which said elastic return means or said element or said case includes, in an engaged position between a first drive element secured to said first internal mobile or formed by said first internal mobile and a second internal mobile internal to said case, and an inactive position in the absence of said adjustment tool, in which inactive position said elastic return means keeps said first drive element disengaged from said second internal mobile, said elastic return means being arranged to supply on its own the desired torque to ensure adjustment.

24. The horological assembly according to claim 23, wherein said first magnetic areas are arranged to cooperate, in said active position, in complementary manner by axial attraction or repulsion parallel to the direction of said first axis with said first internal mobile.

25. The horological assembly according to claim 23, wherein said first internal mobile includes a plurality of radial arms defining, in projection on a plane perpendicular to said first axis, a particular geometric shape, and said first magnetic areas include a plurality of magnets arranged radially around a second axis according to said particular geometric shape, so as to achieve an encoded magneto-mechanical connection specific to said horological assembly alone.

26. The horological assembly according to claim 23, wherein said first magnetic areas include a plurality of magnets arranged radially around a second axis according to the direction of which their magnetic field axis extends, and which are in alternating polarity.

27. The horological assembly according to claim 23, wherein said first internal mobile is ferromagnetic.

28. The horological assembly according to claim 27, wherein said first ferromagnetic internal mobile has a particular shape arranged to minimise the effects of attraction, rotation or repulsion of a uniform external magnetic field of 1.5 Tesla, and to prevent rotation of said first ferromagnetic internal mobile under the action of said uniform external magnetic field of 1.5 Tesla.

29. The horological assembly according to claim 28, wherein said first ferromagnetic internal mobile includes a plurality of radial arms which extend radially as far as the largest radius in which said first internal mobile is movable about said first axis.

30. The horological assembly according to claim 23, wherein said element is a component made of non-magnetic material.

31. The horological assembly according to claim 23, wherein said first internal mobile is pivotably guided about a first axis by a shaft or a bearing that at least one said watch includes.

32. The horological assembly according to claim 23, wherein each said watch is a non-magnetic watch.

33. The horological assembly according to claim 23, wherein at least one said watch is a mechanical watch.

34. The horological assembly according to claim 23, wherein at least one said watch is an electromechanical or electronic watch.

35. The horological assembly according to claim 23, wherein said second internal movement is a mobile for controlling the rate adjustment of a regulating member included in at least one said watch.

36. The horological assembly according to claim 23, wherein said second internal movement is a mobile for controlling the time setting of at least one said watch.

37. The horological assembly according to claim 23, wherein said second internal mobile is a mobile for controlling the setting of a calendar mechanism included in at least one said watch.

38. The horological assembly according to claim 23, wherein said second internal mobile is a mobile for controlling the winding of at least one said watch.

39. The horological assembly according to claim 23, wherein said second internal mobile is a mobile for controlling the setting of an alarm and/or striking work mechanism included in at least one said watch.

40. The horological assembly according to claim 23, wherein said first internal mobile is invisible to the user of at least one said watch.

41. The horological assembly according to claim 23, wherein at least one said watch is devoid of any external mechanical adjustment member passing through the casing of said watch.

42. The horological assembly according to claim 23, wherein at least one said watch is sealed against gases and ambient humidity, and its casing includes for this purpose at least one sealing area suitable for carrying out a metallic or ceramic or glass sealing treatment in a vacuum or in a neutral gas atmosphere.

43. The horological assembly according to claim 23, wherein at least one said watch is sealed to be depressurised so as to be insensitive to variations in internal pressure caused by variations in temperature.

44. The horological assembly according to claim 23, wherein at least one of said watches is equipped with an RFID chip or a passive means of identification allowing direct identification after sale of the nature of said horological assembly to which said watch belongs, and of said adjustment tool to be used.
